(19) United States
(12) Patent Application Publication
(10) Pub. No.: US 2023/0173990 A1
(43) Pub. Date: Jun. 8, 2023

(54) PICKUP TRUCK RACK

(71) Applicant: FORCOME (ZHEJIANG) CO., LTD., Jinhua (CN)

(72) Inventors: Xiaojun NI, Jinhua (CN); Chengsheng FANG, Jinhua (CN); Jing XIONG, Jinhua (CN); Yongjin XU, Jinhua (CN)

(21) Appl. No.: 17/672,608

(22) Filed: Feb. 15, 2022

(30) Foreign Application Priority Data
Dec. 6, 2021 (CN) 202111474892.5

(51) Int. Cl. B60R 9/06; B60J 7/16

(52) U.S. Cl. CPC B60R 9/06; B60J 7/1607

(57) ABSTRACT

A pickup truck rack includes a fastening base, a support frame, a fastening rod, and a fastening frame. There are two fastening bases. One support frame is fastened on each of upper ends of the two fastening bases. Rail grooves are provided at both an upper end and a lower end of the fastening rod. The fastening frame and two support frames are respectively disposed at the upper end and lower end of the fastening rod and are reciprocable or fixable along the corresponding rail grooves. The support frame is a retractable support frame formed by an inner tube and an outer tube that are sleeved. A vertical sliding groove is opened on the inner tube. A clip is provided inside the sliding groove. A bolt through hole is provided at an upper end of the outer tube.

The present application claims priority to Chinese Patent Application No. CN 202111474892.5, filed on Dec. 6, 2021, which is incorporated by reference for all purposes as if fully set forth herein.

### FIELD OF THE INVENTION

The present invention relates to a rack.

### DESCRIPTION OF THE RELATED ART

In existing vehicle racks, a fastening base is generally fastened on a sideboard on each of two sides of a trailer of a truck or a pickup truck. One vertical support frame is connected to each of the two fastening bases. Upper ends of the two support frames are connected by one fastening rod. A fastening frame, for example, a simple vehicle rack in Patent Publication Number CN 210310582U, is provided on the fastening rod. In these existing vehicle racks, the height of a fastening rod and a fastening frame of such a vehicle rack are generally less than the height of the front. With such a design, when a pickup truck enters or exits a garage or a road with a low height limit, a rack is prevented from hitting the top of the garage or a height limit obstacle. However, the height of such an existing vehicle rack is not adjustable. It becomes impossible to transport a relatively long cargo such as a pipe. For some racks higher than the front, when a vehicle passes through a road with a low height limit, or enters a low garage after a cargo is unloaded, a support frame of a rack needs to be detached from the fastening base and placed in a trailer of the vehicle before the vehicle can travel through the road with a low height limit or enter the garage. It is very inconvenient to use such a vehicle rack.

### SUMMARY OF THE INVENTION

In view of disadvantages in an existing pickup truck rack, a technical problem to be solved by the present invention is to provide a pickup truck rack with an adjustable height. In addition, the pickup truck rack is foldable.

To achieve the foregoing objective, according to an aspect of the present invention, the present invention employs the following technical solutions: A pickup truck rack includes a fastening base, a support frame, a fastening rod, and a fastening frame, where there are two fastening bases, one support frame is fastened on each of upper ends of the two fastening bases, rail grooves are provided at both an upper end and a lower end of the fastening rod, the fastening frame and the two support frames are disposed at the upper end and the lower end of the fastening rod respectively, and are reciprocable or fixable along the corresponding rail grooves,

the support frame is a retractable support frame formed by an inner tube and an outer tube that are sleeved, a vertical sliding groove is opened on the inner tube, a clip is provided inside the sliding groove, a bolt through hole is provided at an upper end of the outer tube, the outer tube is connected to the clip in the sliding groove by a bolt passing through the bolt through hole,

an upper connector is disposed at an upper end of the inner tube of the support frame, the upper connector is movably fastened to the rail groove at the bottom of the fastening rod, so that the support frame can reciprocate along a sliding groove on a bottom surface of the fastening rod, and the support frame is fixable to the fastening rod.

In the pickup truck rack, the support frame is designed to be retractable, and through the fastening of the clip and the bolt, the height of the pickup truck rack is adjustable. In addition, the fastening is relatively reliable.

Preferably, an upper through hole and a lower through hole are opened in tube walls on two sides at a lower end of the outer tube of the support frame, an upper sleeving is connected between the two upper through holes, a lower sleeving is connected between the two lower through holes, and opposite clamping grooves are opened in inner walls of the upper sleeving,

the fastening base is formed by a base body, a movable clamp, and a fastening bolt, a lower connector is disposed at an end of a top surface of the base body, the base body is fastened to a sideboard of a trailer of a vehicle by the movable clamp and the fastening bolt, the lower connector is formed by two parallel right-angle sector plates and a baffle connected between ends of the two right-angle sector plates at the same side, a hinge hole is opened on each of the right-angle sector plates at a position close to the center thereof, an arc-shaped through groove is opened in each right-angle sector plate with the hinge hole being the center, one limit hole with a diameter greater than a width of the arc-shaped through groove is opened at each of two ends of the arc-shaped through groove, the lower end of the outer tube of the support frame is inserted in the lower connector, a hinge bolt passes through the hinge hole of the lower connector and the lower sleeving of the outer tube of the support frame to be fastened by the bolt, so that the support frame turnable around the hinge bolt toward a side without the baffle of the lower connector,

the pickup truck rack further includes a positioning pin and a knob, the positioning pin is a stepped pin formed by a small shaft and a large shaft, an external thread is provided on an outer wall of the small shaft, a pin cap is disposed at an end of the large shaft far away from the small shaft, a clamping shaft through hole is opened in the middle of the small shaft and radially extends through the small shaft, a clamping shaft is tightly inserted in the clamping shaft through hole, two ends of the clamping shaft extend from the small shaft, a central through hole is opened at the center of the knob, an internal thread is provided on an inner wall of the central through hole, the small shaft of the positioning pin passes through the arc-shaped through grooves on two sides of the lower connector and the upper sleeving between the two arc-shaped through grooves, and is connected to the central through hole of the knob by threaded connection, in addition, the clamping shaft is clamped with the clamping groove, a diameter of the large shaft of the positioning pin is greater than that of the arc-shaped through groove, the large shaft is tightly inserted in the limit hole, a compression spring is further sleeved outside the large shaft of the positioning pin, the compression spring is a tapered compression spring, a small end of the compression spring abuts against the pin cap, and a large end of the compression spring abuts against the lower connector. In the foregoing design, in a process of loosening the knob, because the compression spring is disposed on the positioning pin, an end of the positioning pin with the pin cap moves outward from the lower connector under the action of the compression spring, so that the large shaft of the positioning pin is detached from the limit hole at an upper end, the support frame and the positioning pin may slide downward along the arc-shaped through groove to turn toward the limit hole at a lower end of the arc-shaped through groove, the support frame tilts to make the fastening rod lower than the front, to allow a pickup truck to successfully enter a garage, it is more convenient to use. If the support frame needs to be erected again for use, an upper end of the support frame is raised, to make a lower end of the support frame and the positioning pin slide upward along the arc-shaped through groove of the lower connector to the limit hole at the upper end, then the knob is tightened, so that the end of the positioning pin with the pin cap moves into the lower connector, the large shaft of the positioning pin enters the upper limit hole of the arc-shaped through groove to make the support frame vertically fastened, and in this way, the pickup truck rack may be foldable.

Preferably, a protecting cover is disposed outside the pin cap of the positioning pin.

Compared with the prior art, the present invention has the following advantages: the height of the pickup truck rack is adjustable through vertical retraction, and may be adjusted in a folding manner, and thus the rack is more convenient to use.

### BRIEF DESCRIPTION OF THE DRAWINGS

The accompanying drawings that constitute a part of the present invention are used to provide a further understanding of the present invention, and the schematic embodiments and the description thereof of the present invention are used to explain the present invention and not intended to limit the present invention.

FIG. 1 is a schematic view of a pickup truck rack according to the present invention.

FIG. 2 is a schematic view of a fastening base according to the present invention.

Reference numerals: 1, fastening base; 2, support frame; 3, fastening rod; 4, fastening frame; 5, inner tube; 6, outer tube; 7, bolt; 8, sliding groove; 9, upper connector; 10, lower connector; 11, knob; 12, protecting cover; 13, base body; 15, positioning pin; 17, upper sleeving; 18, lower sleeving; 19, clamping groove; 20, hinge hole; 21, arc-shaped through groove; 22, upper limit hole; 23, lower limit hole; 24, small shaft; 25, large shaft; 26, pin cap; 27, clamping shaft; 28, compression spring; 29, central through hole; and 30, hinge bolt.

### DETAILED DESCRIPTION OF THE PREFERRED EMBODIMENTS

The present invention is described below in detail with reference to the accompanying drawings and in combination with the embodiments. It should be noted that the embodiments in the present application and the features in the embodiments may be combined with each other without causing any conflict.

In the description of the present invention, it needs to be understood that orientation or location relationships indicated by terms “center”, “up”, “down”, “left”, “right”, “vertical”, “horizontal”, “inner”, “outer”, “bottom”, and “top” are based on orientation or location relationships shown in the accompanying drawings, and are only used to facilitate description of the present invention and simplify description, but are not used to indicate or imply that the apparatuses or elements must have specific orientations or are constructed and operated in specific orientations, and therefore, cannot be understood as a limit to the present invention.

### Embodiment 1

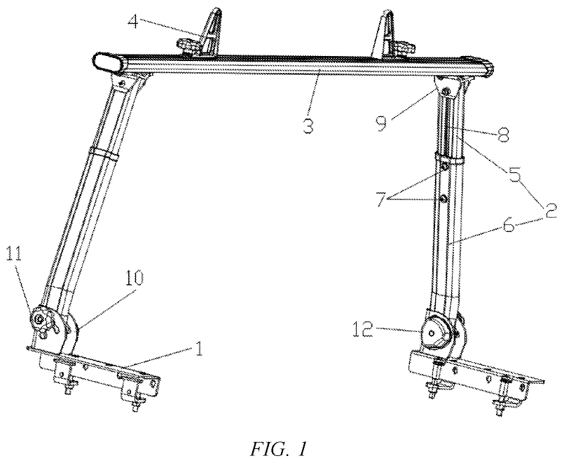

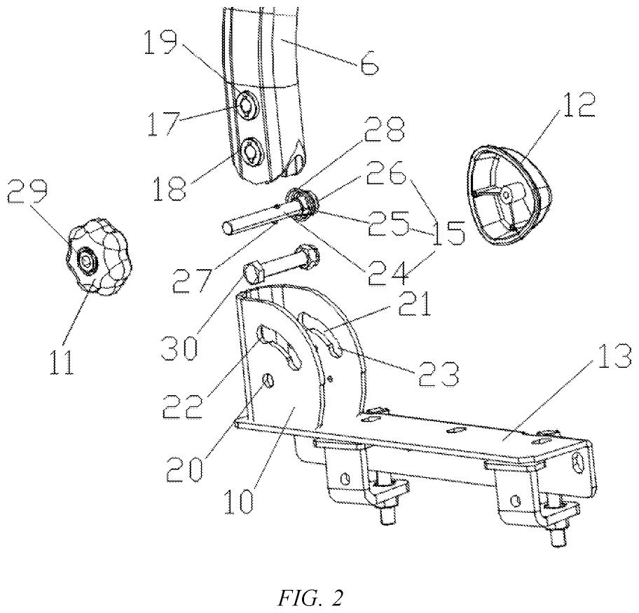

Referring to FIG. 1 and FIG. 2, a pickup truck rack of this embodiment includes a fastening base 1, a support frame 2, a fastening rod 3, a fastening frame 4, a hinge bolt 30, a knob 11, a compression spring 28, a clamping shaft 27, a positioning pin 15, and a protecting cover 12. A sliding groove is opened in each of the top surface and the bottom surface of the fastening rod 3 in a horizontal direction of the fastening rod 3. There are two fastening frames 4. The fastening frame 4 can reciprocate along the sliding groove on the top surface of the fastening rod 3. The fastening frame 4 is fixable to the fastening rod 3. There are two fastening bases 1. One support frame 2 is fastened on each of the two fastening bases 1. The support frame 2 is formed by an inner tube 5 and an outer tube 6 that are sleeved. A vertical sliding groove 8 is opened on the inner tube 5 of the support frame 2. A clip is provided inside the sliding groove 8. A bolt through hole is provided at an upper end of the outer tube 6. The outer tube 6 is connected to the clip in the sliding groove 8 of the inner tube 5 by a bolt 7 passing through the bolt through hole. An upper connector 9 is disposed at an upper end of the inner tube 5. The upper connector 9 is fittingly fastened to the sliding groove at the bottom of the fastening rod 3, so that the support frame 2 can reciprocate along the sliding groove on the bottom surface of the fastening rod 3. The support frame 2 is fixable to the fastening rod 3. An upper through hole and a lower through hole are opened in tube walls on two sides at a lower end of the outer tube 6 of the support frame 2. An upper sleeving 17 is connected between the two through holes at an upper end. A lower sleeving 18 is connected between the two through holes at the lower end. Two clamping grooves 19 are axially opened on an upper inner wall and a lower inner wall of the upper sleeving 17 correspondingly.

The fastening base 1 is formed by a base body 13, a movable clamp, and a fastening bolt. The base body 13 is fastened to a sideboard of a trailer of a vehicle by the movable clamp and the fastening bolt. The base body 13 is a right-angle aluminum alloy plate. The foregoing structure belongs to the prior art. A lower connector 10 is fastened on the top surface of the base body 13 at a left end thereof. The lower connector 10 is formed by two parallel right-angle sector plates and a baffle connected between the ends of the two right-angle sector plates. A hinge hole 20 is opened on each of the right-angle sector plates at a position close to the center thereof. An arc-shaped through groove 21 is opened in each right-angle sector plate. One limit hole with a diameter greater than a width of the arc-shaped through groove 21 is opened in each of the right-angle sector plates at two end portions of the arc-shaped through groove 21. The limit hole at an upper end is an upper limit hole 22. The limit hole at a lower end is a lower limit hole 23. The lower end of the outer tube 6 of the support frame 2 is inserted in a cavity defined by the two right-angle sector plates and the baffle of the lower connector 10. The hinge bolt 30 passes through the hinge hole 20 of the right-angle sector plate on one side of the lower connector 10, then passes through the lower sleeving 18 at the lower end of the outer tube 6 of the support frame 2, and then passes through the hinge hole 20 on the other side of the lower connector 10 to be fastened by a nut, so that the support frame 2 can turn around the hinge bolt 30 toward a side of the lower connector 10 without the baffle. The positioning pin 15 is a stepped pin formed by a small shaft 24 and a large shaft 25. An external thread is provided on an outer wall of the small shaft 24. A pin cap 26 is disposed on the large shaft 25 at an end thereof far away from the small shaft 24. A clamping shaft through hole is vertically opened in the middle of the small shaft 24 and extends through the small shaft 24. The clamping shaft 27 is tightly inserted in the clamping shaft through hole. Two ends of the clamping shaft 27 extend from the small shaft 24. A central through hole 29 is opened at the center of the knob 11. An internal thread is provided on an inner wall of the central through hole 29. The small shaft 24 of the positioning pin 15 is inserted from the upper limit hole 22 on one side of the lower connector 10, then passes through the upper sleeving 17 at the lower end of the outer tube 6 of the support frame 2, and then is connected to the central through hole of the knob 11 by threaded connection, so that the large shaft 25 of the positioning pin 15 is tightly inserted in the upper limit hole 22 of the lower connector 10. The compression spring 28 is further sleeved outside the large shaft 25 of the positioning pin 15. The compression spring 28 is a tapered compression spring. One end with a small opening of the compression spring 28 abuts against the pin cap 26, and the other end with a large opening abuts against the lower connector 10. The protecting cover 12 is disposed outside the pin cap 26 of the positioning pin 15.

In the pickup truck rack of this embodiment, the support frame of a vehicle rack in the prior art is configured as a retractable support frame formed by the inner tube 5 and the outer tube 6. When the height of the support frame 2 needs to be adjusted, the height can be adjusted by loosening the bolt 7 at the upper ends of the inner tube 5 and the outer tube 6 of the support frame 2. The bolt 7 is then tightened after the height is adjusted. When a relatively long cargo such as a pipe needs to be transported, the height of the support frame 2 may be increased, so that the fastening rod 3 is higher than the front of a pickup truck. However, during use, the height adjustment is relatively complex. After a cargo is unloaded, it is only necessary to loosen the knob 11 at a lower end of the support frame 2. In a process of loosening the knob 11, because the compression spring 28 is disposed on the positioning pin 15, the end of the positioning pin 15 with the pin cap 26 can move outward from the lower connector 10 under the action of the compression spring 28, so that the large shaft 25 of the positioning pin 15 is detached from the upper limit hole 22. The support frame 2 and the positioning pin 15 may slide downward along the arc-shaped through groove 21 to turn toward the lower limit hole 23 of the arc-shaped through groove 21. The support frame 2 tilts to make the fastening rod 3 lower than the front, to allow the pickup truck to successfully enter a garage. It is more convenient to use. If the support frame 2 needs to be erected again for use, an upper end of the support frame 2 is raised, so that the lower end of the support frame 2 and the positioning pin 15 slide upward along the arc-shaped through groove 21 of the lower connector 10 to the upper limit hole 22. Then the knob 11 is tightened, so that the end of the positioning pin 15 with the pin cap 26 moves into the lower connector 10. The large shaft 25 of the positioning pin 15 tightly enters the upper limit hole 22 to make the support frame 2 vertically fastened.

The above description is merely preferred embodiments of the present invention, and is not intended to limit the present invention. Various changes and variations may be made to the present invention by a person skilled in the art. Within the spirit and principles of the present invention, any modifications, equivalent substitutions, improvements, and the like are within the protection scope of the present invention.

What is claimed is:

1. A pickup truck rack, comprising:
a fastening base,
a support frame,
a fastening rod, and
a fastening frame,
wherein there are two fastening bases, one support frame is fastened on each of upper ends of the two fastening bases, rail grooves are provided at both an upper end and a lower end of the fastening rod, the fastening frame and the two support frames are disposed at the upper end and the lower end of the fastening rod respectively, and are reciprocable or fixable along the corresponding rail grooves,
wherein the support frame is a retractable support frame formed by an inner tube and an outer tube that are sleeved, a vertical sliding groove is opened on the inner tube, a clip is provided inside the sliding groove, a bolt through hole is provided at an upper end of the outer tube, and the outer tube is connected to the clip in the sliding groove by a bolt passing through the bolt through hole, and
wherein an upper connector is disposed at an upper end of the inner tube of the support frame, the upper connector is movably fastened to the rail groove at the bottom of the fastening rod, so that the support frame can reciprocate along a sliding groove on a bottom surface of the fastening rod, and the support frame can be fixed to the fastening rod.

2. The pickup truck rack according to claim 1,
wherein an upper through hole and a lower through hole are opened in tube walls on two sides at a lower end of the outer tube of the support frame, an upper sleeving is connected between the two upper through holes, a lower sleeving is connected between the two lower through holes, and opposite clamping grooves are opened in inner walls of the upper sleeving,
wherein the fastening base comprises a base body, a movable clamp, and a fastening bolt, a lower connector is disposed at an end of a top surface of the base body, the base body is fastened to a sideboard of a trailer of a vehicle by the movable clamp and the fastening bolt, the lower connector is formed by two parallel right-angle sector plates and a baffle connected between ends of the two right-angle sector plates, a hinge hole is opened on each of the right-angle sector plates at a position close to the center thereof, an arc-shaped through groove is opened in each right-angle sector plate with the hinge hole being the center, one limit hole with a diameter greater than a width of the arc-shaped through groove is opened at each of two ends of the arc-shaped through groove, the lower end of the outer tube of the support frame is inserted in the lower connector, and a hinge bolt passes through the hinge hole of the lower connector and the lower sleeving of the outer tube of the support frame to be fastened by the bolt, so that the support frame turnable around the hinge bolt toward a side without the baffle of the lower connector, and
wherein the pickup truck rack further comprises a positioning pin and a knob, the positioning pin is a stepped pin formed by a small shaft and a large shaft, an external thread is provided on an outer wall of the small shaft, a pin cap is disposed at an end of the large shaft far away from the small shaft, a clamping shaft through hole is opened in the middle of the small shaft and radially extends through the small shaft, a clamping shaft is tightly inserted in the clamping shaft through hole, two ends of the clamping shaft extend from the small shaft, a central through hole is opened at the center of the knob, an internal thread is provided on an inner wall of the central through hole, the small shaft of the positioning pin passes through the arc-shaped through grooves on two sides of the lower connector and the upper sleeving between the two arc-shaped through grooves, and is connected to the central through hole of the knob by threaded connection, in addition, the clamping shaft is clamped with the clamping groove, a diameter of the large shaft of the positioning pin is greater than that of the arc-shaped through groove, the large shaft is tightly inserted in the limit hole, a compression spring is further sleeved outside the large shaft of the positioning pin, the compression spring is a tapered compression spring, a small end of the compression spring abuts against the pin cap, and a large end of the compression spring abuts against the lower connector.

3. The pickup truck rack according to claim 2, wherein a protecting cover is disposed outside the pin cap of the positioning pin.
